(19) United States
(12) Patent Application Publication
(10) Pub. No.: US 2019/0000116 A1
(43) Pub. Date: Jan. 3, 2019

(54) Process for Preparing Non-Cariogenic, Sustained Energy Release Juice

(71) Applicant: Petiva Private Limited, Hyderabad (IN)

(72) Inventors: Banibrata Pandey, Hyderabad (IN); Rahul Raju Kanumuru, Hyderabad (IN); Saravanakumar Iyappan, Hyderabad (IN); Karthikeyan Venkata Narayanan, Hyderabad (IN); Humaira Parveen Sheikh, Hyderabad (IN)

(21) Appl. No.: 16/061,969

(22) PCT Filed: Nov. 12, 2016
(86) PCT No.: PCT/IB2016/056827

§ 371 Date: Jun. 13, 2018

(30) Foreign Application Priority Data
Nov. 12, 2015 (IN) 2416/CHE/2015
Nov. 12, 2015 (IN) 2417/CHE/2015

(51) Int. Cl. A23L 2/84; A23L 2/02

(52) U.S. Cl. CPC A23L 2/84; A23V 2002/00; A23L 2/02

(57) ABSTRACT

The present invention provides a process for preparing non-cariogenic, sustained energy release juice. The process comprises contacting juice with an enzyme immobilized on Duolite at 30-50° C. for 1-5 h; wherein the enzyme is capable of converting cariogenic sugar to non-cariogenic sugar; and separating juice from the enzyme complex.

This application claims the benefit of Indian provisional application number 2416/CHE/2015, filed on Nov. 12, 2015 and Indian provisional application number 2417/CHE/2015, filed on Nov. 12, 2015; which hereby incorporated by reference.

### FIELD OF THE INVENTION

The present invention relates to juice. In particular, the present invention relates to a process for preparing non-cariogenic, sustained energy release juice.

### BACKGROUND OF THE INVENTION

Juice is considered healthy in terms of valuable nutrients such as vitamins and minerals, but the presence of high sugar content would become a key factor in weight gain if not consumed in moderation. Additionally, these juices are not stable for longer time and hence to be consumed immediately as the sugar present therein is fermentable in nature. In recent years, there has been increasing concern as to the cariogenic properties of sugar. Reduction of sugar could be achieved by dilution with water and sweetness is adjusted with artificial sweeteners. However, this process results in reducing intrinsic quality such as minerals and vitamins, etc. of juice. Another way of achieving the same is by targeted fermentation to other product and thereby reducing the sugar composition. However, in both the cases the negative impact might reduce the success of the products such as after-taste or undesired product formation which impairs the taste. Thus, there is desire to develop a process producing non-cariogenic, sustained energy release juice.

The present invention provides a solution to the above-mentioned problem(s) by process for converting the sugar present in the juice to their isomeric or epimeric form which not only keep the natural ingredient as in original juice but having less calorific value along with less glycemic index and with extended self-life without any preservatives.

### SUMMARY OF THE INVENTION

In one aspect, the present invention relates to a process for preparing non-cariogenic, sustained energy release juice comprising:
a. contacting juice with an enzyme immobilized on Duolite at 30-50° C. for 1-5 h; wherein the enzyme is capable of converting cariogenic sugar to non-cariogenic sugar; and
b. separating juice from the enzyme complex.
   The process may comprise optionally, adjusting pH of the juice before and after contacting with the immobilized enzyme.

An advantage of the present invention is the use of immobilized enzyme rather than free enzyme which is having increased lifetime due to the immobilization in combination with a juice as a substrate to affect the desired properties as intended in the invention.

Another advantage of the present invention is that energy and resources can be saved using immobilized enzyme.

### BRIEF DESCRIPTION OF THE DRAWINGS

FIG. 1 Illustrates Analysis of Sugar Profile in Grape Juice

Grape juice was freshly prepared by crushing and subsequent clarification. The juice solution was subjected to HPLC analysis to identify and measure the composition of sugars. The sugar peaks were confirmed with commercially available standards (Sigma Aldrich). The pH of the juice is adjusted to 8.0 prior to contacting with enzyme for alteration of sugar composition. The composition of sugars in orange juice is shown in graphical representation (A) and the amount of each sugar present is given in B.

FIG. 2 Illustrates Analysis of Sugar Profile in Grape Juice

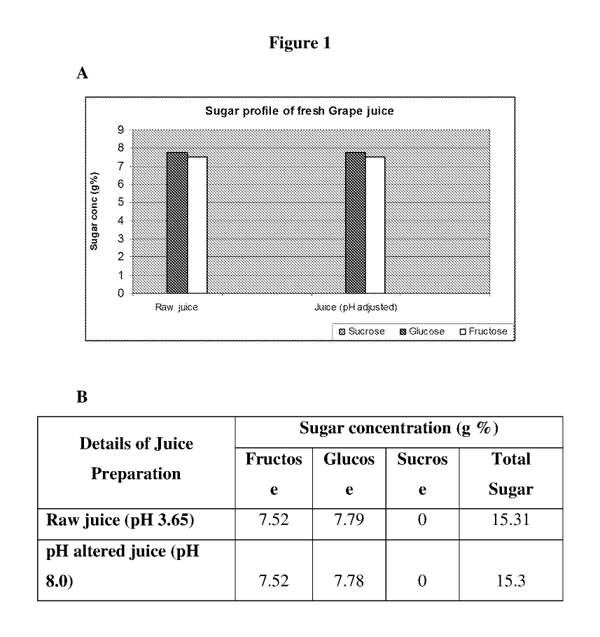

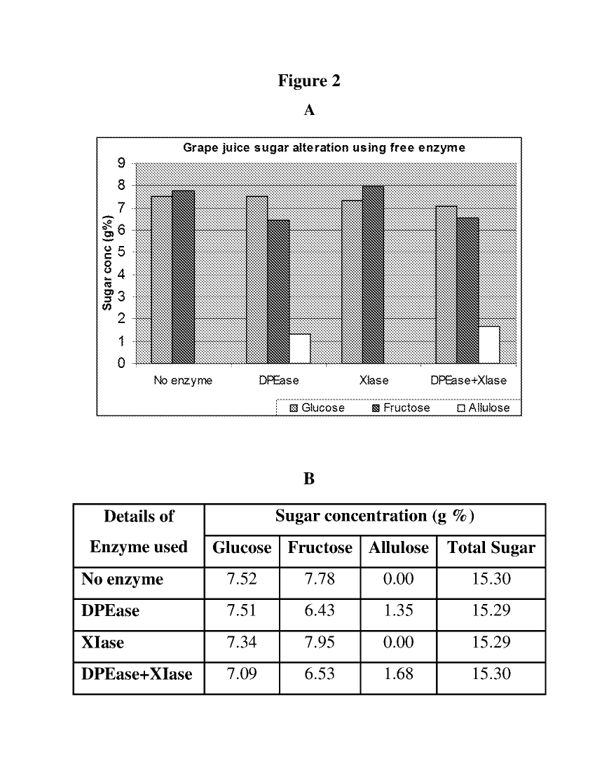

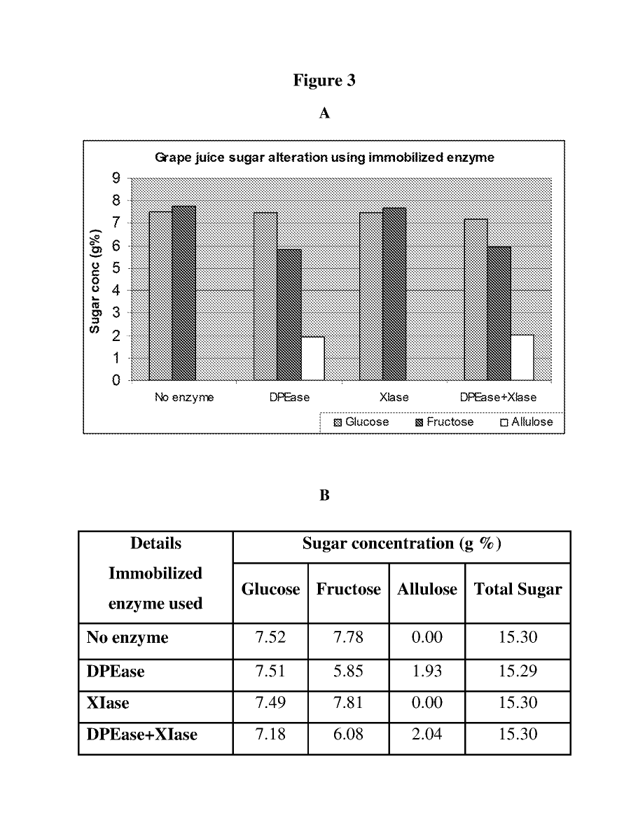

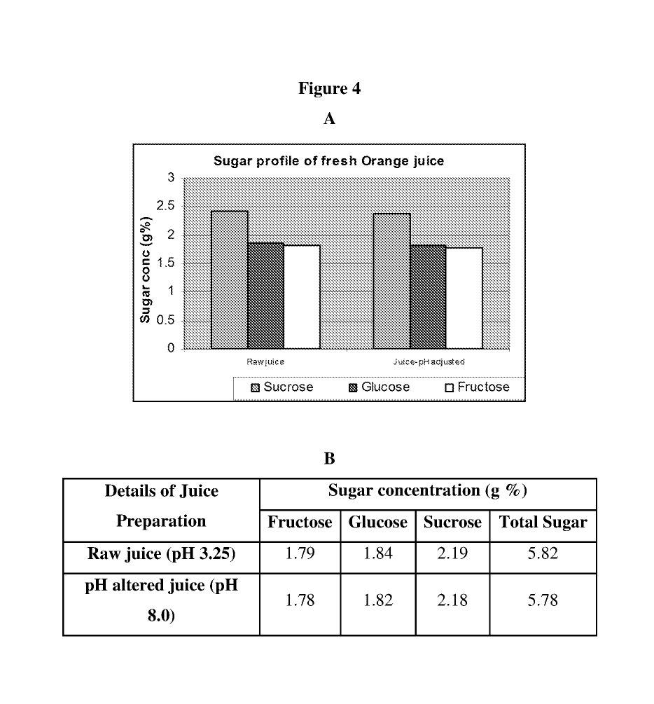

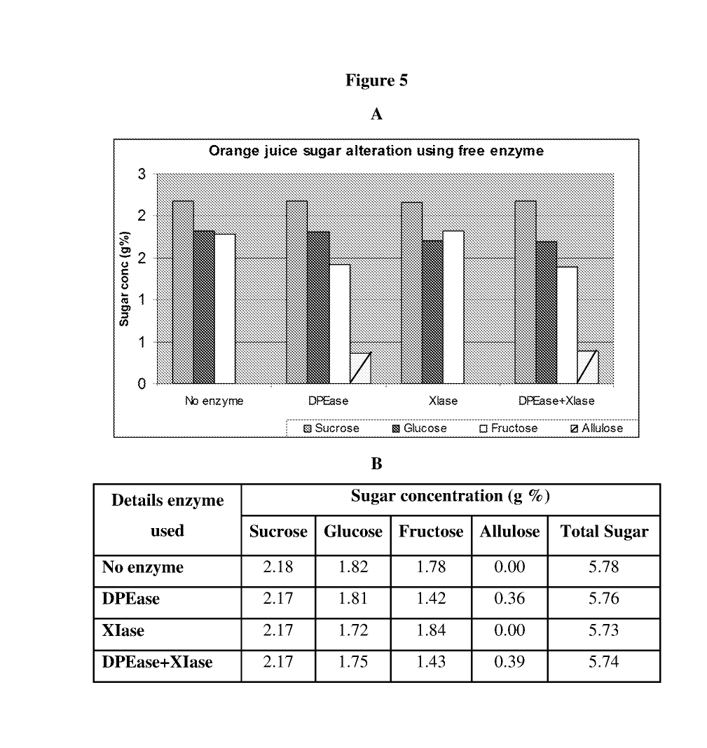

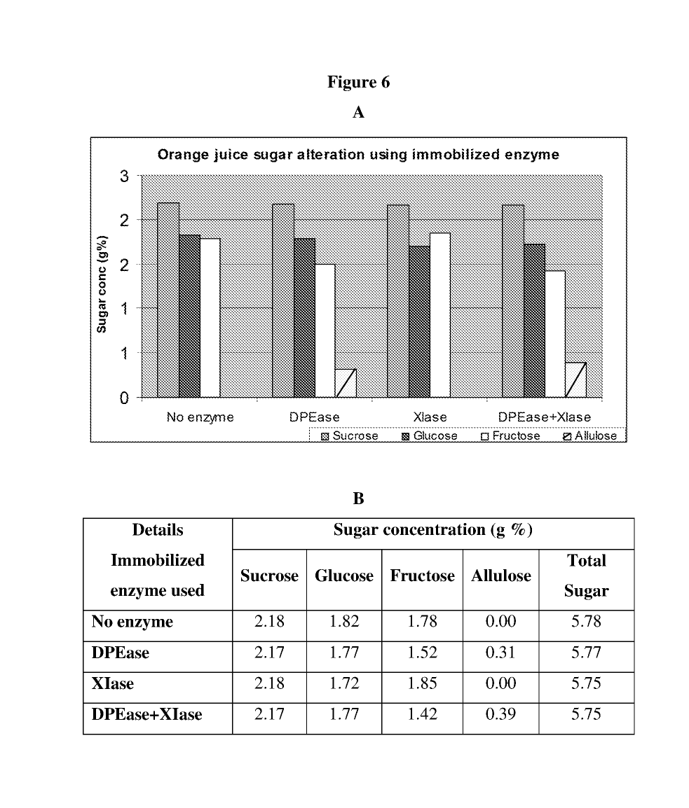

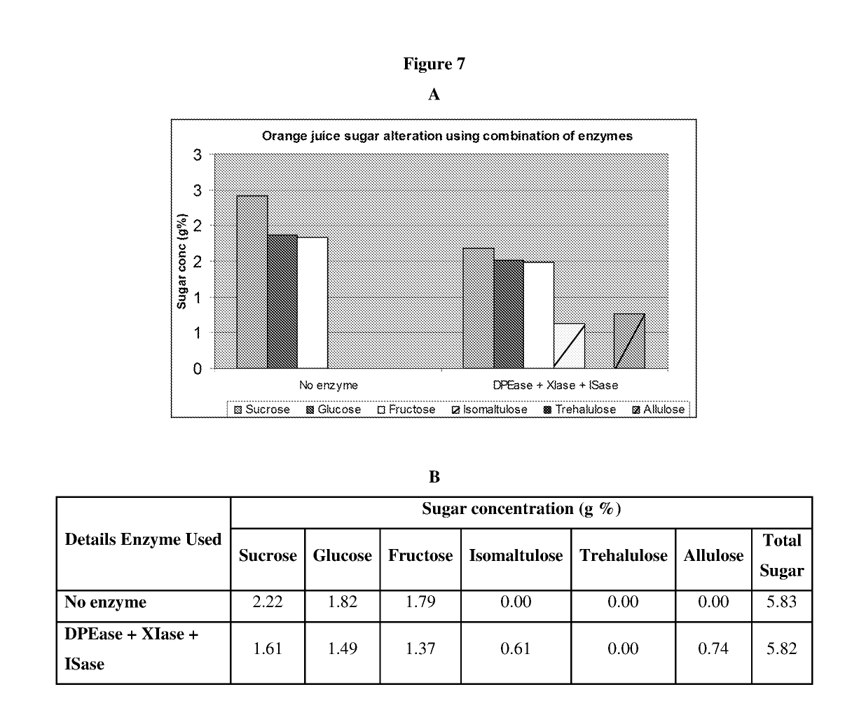

The pH of the freshly prepared grape juice was adjusted to 8.0 and incubated with respective enzymes at optimum reaction conditions for conversion of natural sugars present in the juice in to rare sugars. After bioconversion, the juice solution was subjected to HPLC analysis to identify and measure the composition of sugars. The sugar peaks were confirmed with commercially available standards (Sigma Aldrich). The composition of altered sugars in orange juice by different enzymes is shown in graphical representation (A) and the amount of each sugar present is given in B. Abbreviations are:—DPEase: D-Psicose 3-epimerase, XIase: Xylose isomerase.

FIG. 3 Illustrates Analysis of Sugar Profile in Grape Juice

The pH of the freshly prepared grape juice was adjusted to 8.0 and incubated with respective enzymes immobilized on solid surface at optimum reaction conditions for conversion of natural sugars present in the juice in to rare sugars. After bioconversion, the juice solution was subjected to HPLC analysis to identify and measure the composition of sugars. The sugar peaks were confirmed with commercially available standards (Sigma Aldrich). The composition of altered sugars in orange juice by different enzymes is shown in graphical representation (A) and the amount of each sugar present is given in B. Abbreviations are:—DPEase: D-Psicose 3-epimerase, XIase: Xylose isomerase.

FIG. 4 Illustrates Analysis of Sugar Profile in Orange Juice

Orange juice was freshly prepared by crushing and subsequent clarification. The juice solution was subjected to HPLC analysis to identify and measure the composition of sugars. The sugar peaks were confirmed with commercially available standards (Sigma Aldrich). The pH of the juice is adjusted to 8.0 prior to contacting with enzyme for alteration of sugar composition. The composition of sugars in orange juice is shown in graphical representation (A) and the amount of each sugar present is given in B.

FIG. 5 Illustrates Analysis of Sugar Profile in Orange Juice

The pH of the freshly prepared orange juice was adjusted to 8.0 and incubated with respective enzymes at optimum reaction conditions for conversion of natural sugars present in the juice in to rare sugars. After bioconversion, the juice solution was subjected to HPLC analysis to identify and measure the composition of sugars. The sugar peaks were confirmed with commercially available standards (Sigma Aldrich). The composition of altered sugars in orange juice by different enzymes is shown in graphical representation (A) and the amount of each sugar present is given in B. Abbreviations are:—DPEase: D-Psicose 3-epimerase, XIase: Xylose isomerase.

FIG. 6 Illustrates Analysis of Sugar Profile in Orange Juice

The pH of the freshly prepared orange juice was adjusted to 8.0 and incubated with respective enzymes immobilized on solid surface at optimum reaction conditions for conversion of natural sugars present in the juice in to rare sugars. After bioconversion the juice solution was subjected to HPLC analysis to identify and measure the composition of sugars. The sugar peaks were confirmed with commercially available standards (Sigma Aldrich). The composition of altered sugars in orange juice by different enzymes is shown in graphical representation (A) and the amount of each sugar present is given in B. Abbreviations are:—DPEase: D-Psicose 3-epimerase, XIase: Xylose isomerase.

FIG. 7 Illustrates Analysis of Sugar Profile in Orange Juice

The pH of the freshly prepared orange juice was adjusted to 8.0 and incubated with combination of enzymes immobilized on solid surface at optimum reaction conditions for conversion of natural sugars present in the juice in to rare sugars. After bioconversion, the juice solution was subjected to HPLC analysis to identify and measure the composition of sugars. The sugar peaks were confirmed with commercially available standards (Sigma Aldrich). The composition of altered sugars in orange juice by different enzymes is shown in graphical representation (A) and the amount of each sugar present is given in B.

DPEase: D-Psicose 3-epimerase, XIase: Xylose isomerase, ISase: Isomaltulose synthase.

### DETAILED DESCRIPTION OF THE INVENTION

Before the methods of the present disclosure are described in greater detail, it is to be understood that the methods are not limited to particular embodiments described, as such may, of course, vary. It is also to be understood that the terminology used herein is for the purpose of describing particular embodiments only, and is not intended to be limiting, since the scope of the methods will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the methods. The upper and lower limits of these smaller ranges may independently be included in the smaller ranges and are also encompassed within the methods, subject to any specifically excluded limit in the stated range. Where the stated range includes one or both of the limits, ranges excluding either or both of those included limits are also included in the methods.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which the methods belong. Although any methods similar or equivalent to those described herein can also be used in the practice or testing of the methods, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present methods are not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

The term “juice” as used herein refers to “sugar juice” or fruit juice.

The term “sugar juice” as used herein refers to any juice containing sugars derived from a plant source. In exemplary embodiments, the sugar is derived from a plant source, such as, for example, cane or beets. Examples of sugar juices include, but are not limited to, sugar cane juice and sweet sorghum juice.

Examples of fruit include, but are not limited to, juice, orange juice and grape juice.

It is appreciated that certain features of the methods, which are, for clarity, described in the context of separate embodiments, may also be provided in combination in a single embodiment. Conversely, various features of the methods, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed, to the extent that such combinations embrace operable processes and/or devices/systems/kits. In addition, all sub-combinations listed in the embodiments describing such variables are also specifically embraced by the present methods and are disclosed herein just as if each and every such sub-combination was individually and explicitly disclosed herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present methods. Any recited method can be carried out in the order of events recited or in any other order which is logically possible.

In one embodiment, the present invention provides a low calorie, low glycemic index (GI), and sustained energy release sugar composition comprising:

a combination of sugars selected from a group comprising isomaltulose, trehalulose and D-allulose;

at least one of the following: essential trace elements, soluble oligosaccharides and bulking agents; and

optionally, one or more nutritive sweetener.

The term non-cariogenic sugar mainly isomaltulose, trehalulose, allulose.

D-allulose ((D-ribo-2-hexulose, and C₆H₁₂O₆) is a low-energy monosaccharide sugar present in small quantities in natural products. The sweetness of psicose is 70% of the sweetness of sucrose, high solubility clean taste, smooth texture, and desirable mouth feel, no calories and a low glycemic index.

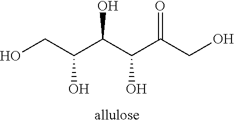 [SMILES: O=C(CO)[C@H](O)[C@H](O)[C@H](O)CO]

Isomaltulose is a disaccharide carbohydrate composed of alpha-1, 6-linked glucose and fructose with a very low GI about 32.

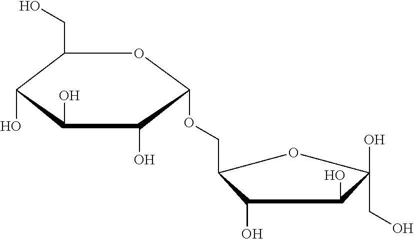

Trehalulose is a disaccharided carbohydrate composed of glucose and fructose also known as 1-O-α-D-glucopyranosyl-β-D-fructofuranose, is more soluble in water than its structural isomers sucrose. This sugar has a sweet taste and has very similar physical and organoleptic properties to sucrose.

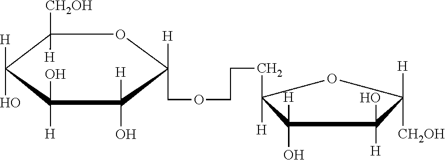

Examples of enzymes are as disclosed in US20150361473 and US20150344865.

The present invention relates, in general terms, to modify the composition of sugars using enzymes specific to sugars present in the juices and convents them into their isomers or epimers. The enzymes used are isolated or produced in GRAS certified organisms by FDA.

For the reasons of economy, it is preferable to use immobilized enzyme in the form of a fixed bed through which the sugar containing juice solution flows in a predetermined flow rate to obtain the desired sugar composition. It may also possible to use plurality of fixed bed reactors with different enzyme complex to obtain the low glycemic and extended release sugars.

The term “immobilized enzyme” in the context of the present invention is an enzyme complex to understand, which is bound to a matrix or enclosed in a matrix so that the enzyme complex capable of acting on a substrate such as sugars without leaching into the aqueous reaction medium.

The immobilization of the enzyme, for example, in the form of insoluble crosslinked enzyme aggregates where the support matrix may be natural or synthetic. Natural materials include polysaccharides such as alginate, agarose, sepharose, cellulose and its derivatives (e.g. As DEAE or CM-cellulose) and synthetic organic polymers can Polystyrene derivatives, polyacrylate, duolite etc. The preferable matrix for immobilization is calcium alginate or duolite. The choice of DUOLITE™ A-568 is preferable as this matrix suitable for all the enzymes of this embodiment which can withstand higher temperature and retain the enzyme activity.

Advantageously the converted sugar is non-fermentable and extending the self-life of the converted juice. It may also advantageous to change the pH of the juice to maximize the enzyme activity and after the desired time period the pH of the converted sugar juice to the original pH and retain the natural constituent without the sweetness of the juice comparable to the original sugar juice.

The cariogenic sugar present in the juice may be partially/completely converted into non-cariogenic sugar by enzymes.

The present invention provides methods for production of juice containing low glycemic sugars. Juice include such as sugar cane juice, sweet sorghum juice, sugar beet juice, orange juice and grape juice. The amount of sugar composition in each of the juices varies depending upon the seasons, varieties, localities and harvesting time as well as methods storing before processing. The various sugar concentration of the raw juice of the present invention is an illustrative one. As an example the freshly harvested raw juice of sugar cane and sweet sorghum are mentioned in below tables; wherein the pH of the juices is ca. 6.0.

TABLE 1

| | Sugar concentration (g %) | | | | | | |
|---|---|---|---|---|---|---|---|
| | Su- | Glu- | Fruc- | | Tre- | | Total |
| | crose | cose | tose | Isomaltulose | halulose | Allulose | Sugar |
| Sugarcane | 7.60 | 2.25 | 3.15 | 0.64 | 0.00 | 0.00 | 13.64 |

TABLE 2

| | Sugar concentration (g %) | | | | | | |
|---|---|---|---|---|---|---|---|
| | Su- | Glu- | Fruc- | | Tre- | | Total |
| | crose | cose | tose | Isomaltulose | halulose | Psicose | Sugar |
| Sorghum | 5.20 | 4.40 | 3.60 | 0.00 | 0.00 | 0.00 | 13.20 |

As an example the sugar composition of freshly prepared fruit juice is mentioned in table below. The fruit juice is generally acidic in nature wherein the pH of the juices is ca. 4.5.

| Details of Juice | Sugar concentration (g %) | | | |
|---|---|---|---|---|
| Preparation | Fructose | Glucose | Sucrose | Total Sugar |
| Grape Raw juice | 7.52 | 7.79 | 0 | 15.31 |
| Orange Raw juice | 1.79 | 1.84 | 2.19 | 5.82 |

In certain embodiments, the cariogenic sugar is one or more of a mono-saccharide or di-saccharide. In certain embodiments, the cariogenic sugar is one or more of sucrose, glucose or fructose.

In certain embodiments, the non-cariogenic sugar is selected from a group comprising isomaltulose, trehalulose and allulose.

In certain embodiments, the enzyme is selected from a group comprising isomaltulose synthase, sucrose isomerase, xylose isomerase, and D-psicose epimerase, and, optionally, along with the enzyme invertaseln certain embodiments, the present invention provides a process to convert fructose present in the juice to D-allulose by incubating it with immobilized D-psicose 3 -epimeras e.

In certain embodiments, the present invention provides a process to convert sucrose present in the juice to isomaltulose and/or trehalulose by incubating it with immobilized isomaltulose synthase and/or sucrose isomerase. These bioconversions either individually or in combination provides different combinations of sugar compositions in juice.

### EXAMPLES

The invention will now be illustrated by means of the following examples, it being understood that these are intended to explain the invention, and in no way to limit its scope.

### Example 1

### Alteration of Sugar Cane Sugar Composition using Isomaltulose Synthase or Sucrose Isomerase

For alteration of sugars present in sugar cane juice the juice was freshly prepared by crushing and subsequent clarification. The freshly prepared sugar cane juice is having pH 5.8±0.2. The freshly prepared juice contains 7.6±0.1% sucrose, 2.2±0.1% glucose and 3.2±0.1% fructose. In order to convert the sucrose to isomaltulose and/or trehalulose, the juice (1 mL) is contacted with the purified isomaltulose synthase and/or sucrose isomerase enzyme (20 IU) immobilized on DUOLITE™ and allowed for bioconversion at 35° C. for 2 to 4 h. After bioconversion, the juice was subjected to HPLC analysis to identify and measure the composition of sugars. The sugar peaks were confirmed with commercially available sucrose, isomaltulose and trehalulose standards (Sigma Aldrich). When juice is contacted with ISase >98% of sucrose is converted to sucrose isomers such as isomaltulose (>82%) and trehalulose (>16%) under given conditions. The amount of isomaltulose and trehalulose reached >50% and >9%, respectively to the total sugar present in the sugar cane juice.

### Example 2

### Alteration of Sugar Cane Sugar Composition using Multiple Enzymes

For alteration of sugars present in sugar cane juice the juice was freshly prepared by crushing and subsequent clarification. The freshly prepared sugar cane juice is having pH 5.8±0.2. The freshly prepared juice contains 7.6±0.1% sucrose, 2.2±0.1% glucose and 3.2±0.1% fructose. In order to convert the existing sucrose, glucose and fructose into isomaltulose and/or trehalulose and allulose, the juice (1 mL) is contacted with purified isomaltulose synthase or sucrose isomerase enzyme, xylose isomerase and D-psicose epimerase (20 IU) immobilized on DUOLITE™ and allowed for bioconversion at 45-50° C. for 2 to 4 h. After bioconversion, the juice was subjected to HPLC analysis to identify and measure the composition of sugars. The sugar peaks were confirmed with commercially available sucrose, isomaltulose, trehalulose standards, glucose, fructose and allulose (Sigma Aldrich). When juice is contacted with above enzymes >89% of sucrose is converted to sucrose isomers such as isomaltulose (>79%) and trehalulose (>10%) under given conditions. The amount of isomaltulose and trehalulose reached >44% and >6%, respectively to the total sugar present in the sugar cane juice. The fructose present in the cane juice is converted in to allulose (>30%) by addition of DPEase and XIase simultaneously. The amount of allulose reached 7 to 8% of total sugar present in the sugar cane juice.

### Example 3

### Alteration of Sugar Cane Sugar Composition by Inversion, Isomerization and Epimerization using Multiple Enzymes

For alteration of sugars present in sugar cane juice the juice was freshly prepared by crushing and subsequent clarification. The freshly prepared sugar cane juice is having pH 5.8±0.2. The freshly prepared juice contains 7.6±0.1% sucrose, 2.2±0.1% glucose and 3.2±0.1% fructose. In order to convert the existing sucrose to glucose, fructose and allulsoe, the juice (1 mL) is contacted with purified invertase, xylose isomerase and D-psicose epimerase (20 IU) immobilized on DUOLITE™ and allowed for bioconversion at 45-50° C. for 2 to 4 h. After bioconversion, the juice was subjected to HPLC analysis to identify and measure the composition of sugars. The sugar peaks were confirmed with commercially available sucrose, glucose, fructose and allulose (Sigma Aldrich). When juice is contacted with Invertase >98% of sucrose is converted to glucose and fructose in a ratio of 48:52 under given conditions. The fructose present in the cane juice is converted in to allulose (>30%) by simultaneous addition of DPEase and XIase. The amount of allulose reached 7 to 8% of total sugar present in the sugar cane juice.

### Example 4

### Alteration of Sweet Sorghum Cane Sugar Composition using Isomaltulose Synthase or Sucrose Isomerase

For alteration of sugars present in sweet sorghum cane juice the juice was freshly prepared by crushing and subsequent clarification. The freshly prepared fruit juice is having pH 5.8±0.2. The freshly prepared juice contains 5.2±0.1% sucrose, 4.4±0.1% glucose and 3.6±0.1% fructose. In order to convert the existing sucrose into isomaltulose and/or trehalulose, the juice (1 mL) is contacted with purified isomaltulose synthase or sucrose isomerase enzyme (20 IU) immobilized on DUOLITE™ and allowed for bioconversion at 35° C. for 2 to 4 h. After bioconversion, the juice was subjected to HPLC analysis to identify and measure the composition of sugars. The sugar peaks were confirmed with commercially available sucrose, isomaltulose and trehalulose standards (Sigma Aldrich). When juice is contacted with ISase >89% of sucrose is converted to rare sucrose isomers such as isomaltulose (>78%) and trehalulose (>8%) under given conditions. The amount of isomaltulose and trehalulose reached >31% and >3%, respectively to the total sugar present in the sweet sorghum cane juice.

### Example 5

### Alteration of Sugar Cane Sugar Composition using Multiple Enzymes

For alteration of sugars present in sugar cane juice the juice was freshly prepared by crushing and subsequent clarification. The freshly prepared sweet sorghum juice is having pH 5.8±0.2. The freshly prepared juice contains 5.2±0.1% sucrose, 4.8±0.1% glucose and 3.61±0.1% fructose. In order to convert the existing sucrose, glucose and fructose into isomaltulose and/or trehalulose and allulose, the juice (1 mL) is contacted with purified isomaltulose synthase or sucrose isomerase enzyme, xylose isomerase and D-psicose epimerase (20 IU) immobilized on DUOLITE™ and allowed for bioconversion at 45-50° C. for 2 to 4 hrs. After bioconversion, the juice was subjected to HPLC analysis to identify and measure the composition of sugars. The sugar peaks were confirmed with commercially available sucrose, isomaltulose, trehalulose standards, glucose, fructose and allulose (Sigma Aldrich). When juice is contacted with above enzymes >89% of sucrose is converted to rare sucrose isomers such as isomaltulose (>57%) and trehalulose (>7%) under given conditions. The amount of isomaltulose and trehalulose reached >22% and >3%, respectively to the total sugar present in the sugar cane juice. The fructose present in the cane juice is converted in to allulose (>30%) by addition of DPEase and XIase simultaneously. The amount of allulose reached 37% of total sugar present in the sweet sorghum cane juice.

### Example 6

### Alteration of Sweet Sorghum Cane Sugar Composition by Inversion, Isomerization and Spimerization using Multiple Enzymes

For alteration of sugars present in sweet sorghum cane juice the juice was freshly prepared by crushing and subsequent clarification. The freshly prepared sweet sorghum juice is having pH 5.8±0.2. The freshly prepared juice contains 5.2±0.1% sucrose, 4.38±0.1% glucose and 3.6±0.1% fructose. In order to convert the existing sucrose in to glucose, fructose and allulsoe, the juice (1 mL) was contacted with purified Invertase, xylose isomerase and D-psicose epimerase (20 IU) immobilized on DUOLITE™ and allowed for bioconversion at 45-50° C. for 2 to 4 h. After bioconversion, the juice was subjected to HPLC analysis to identify and measure the composition of sugars. The sugar peaks were confirmed with commercially available sucrose, glucose, fructose and allulose (Sigma Aldrich). When juice is contacted with Invertase >98% of sucrose is converted to glucose and fructose in a ratio of 48:52 under given conditions. The fructose present in the cane juice is converted in to allulose (>30%) by simultaneous addition of DPEase and XIase. The amount of allulose reached 14 to 15% of total sugar present in the sugar cane juice.

### Example 7

### Alteration of Grape Juice Sugar Composition

For alteration of sugars present in grape juice the juice was freshly prepared by crushing and subsequent clarification. The freshly prepared fruit juice is having pH 3.65. The freshly prepared juice contains 7.5±0.1% glucose and 7.8±0.1% fructose. In order to convert the existing glucose into fructose and/or fructose into allulose by XIase and/or DPEase enzymes, respectively, the pH of the juice is adjusted to 8.0 prior to bioconversion. The sugar profile remains unchanged upon pH adjustment using NaOH/Na₂CO₃ to pH 8.0. Then, the juice (1 mL) was contacted with enzymes (20 IU) immobilized on DUOLITE™ and allowed for bioconversion at 45 to 50° C. for at leaset 4 h. After bioconversion, the juice was subjected to HPLC analysis to identify and measure the composition of sugars using Zorbex carbohydrate column. The sugar peaks were confirmed with commercially available glucose, fructose and allulose standards (Sigma Aldrich). The glucose fructose composition is altered from 7.5±0.1 and 7.8±0.1% to 7.3±0.1 and 7.9±0.1%, respectively when incubated with XIase. When juice is contacted with DPEase >17% of fructose is converted to allulose under given conditions. Addition of both DPEase and XIase simultaneously the formation of allulose is further increased to >21% due increased fructose concentration by inter conversion fructose from glucose by XIase. The amount of allulose reached 9 to 11% of total sugar present in the grape juice.

### Example 8

### Alteration of Grape Juice Sugar Composition

For alteration of sugars present in grape juice the juice was freshly prepared by crushing and subsequent clarification. The freshly prepared fruit juice is having pH 3.65. The freshly prepared juice contains 7.5±0.1% glucose and 7.8±0.1% fructose. In order to convert the existing glucose into fructose and/or fructose into allulose by XIase and/or DPEase enzymes, respectively, the pH of the juice is adjusted to 8.0. The sugar profile remains unchanged upon pH adjustment using NaOH/Na₂CO₃ to pH 8.0 prior to bioconversion. Then, the juice (1 mL) was contacted with enzymes (20 IU) immobilized on DUOLITE™ and allowed for bioconversion at 45 to 50° C. for at least 4 h. After bioconversion, the juice solution was subjected to HPLC analysis to identify and measure the composition of sugars using Zorbex carbohydrate column. The sugar peaks were confirmed with commercially available glucose, fructose and allulose (also known as Psicose) standards (Sigma Aldrich). The glucose fructose composition is altered from 7.5±0.1 and 7.8±0.1% to 7.5±0.1 and 7.8±0.1%, respectively when incubated with XIase. When juice is contacted with DPEase >25% of fructose is converted to allulose under given conditions. Addition of both DPEase and XIase simultaneously the formation of allulose is further increased to >26% due increased fructose concentration by inter conversion fructose from glucose by XIase. The amount of allulose reached 12 to 13% of total sugar present in the grape juice.

### Example 9

### Alteration of Orange Juice Sugar Composition

For alteration of sugars present in grape juice the juice was freshly prepared by crushing and subsequent clarification. The freshly prepared fruit juice is having pH 3.25. The freshly prepared juice contains 1.84±0.1% glucose, 1.79±0.1% and fructose. In order to convert the existing glucose into fructose and/or fructose into allulose by XIase and/or DPEase, respectively, the pH of the juice is adjusted to 8.0 prior to bioconversion. The sugar profile remains unchanged upon pH adjustment using NaOH/Na₂CO₃ to pH 8.0. Then, the juice (1 mL) was contacted with enzymes (20 IU) immobilized on DUOLITE™ and allowed for bioconversion at 45 to 50° C. for at least 4 h. After bioconversion, the juice was subjected to HPLC analysis to identify and measure the composition of sugars using Zorbex carbohydrate column. The sugar peaks were confirmed with commercially available glucose, fructose and allulose (also known as Psicose (Sigma Aldrich). The glucose fructose composition is altered from 1.82±0.1 and 1.78±0.1% to 1.72±0.1 and 1.84±0.1%, respectively when incubated with XIase. When juice is contacted with DPEase >20% of fructose is converted to allulose under given conditions. Addition of both DPEase and XIase simultaneously the formation of allulose is further increased to >21% due increased fructose concentration by inter conversion fructose from glucose by XIase. The amount of allulose reached 6 to 7% of total sugar present in the orange juice, whereas the amount of allulose reached 10 to 11% of total monosaccharides present in the orange juice.

### Example 10

### Alteration of Orange Juice Sugar Composition

Procedure similar to depicted in Example 9 was followed to convert the existing glucose into fructose and/or fructose into allulose by XIase and/or DPEase, respectively. After bioconversion, the juice was subjected to HPLC analysis to identify and measure the composition of sugars using Zorbex carbohydrate column. The sugar peaks were confirmed with commercially available glucose, fructose and allulose (also known as Psicose (Sigma Aldrich). The glucose fructose composition is altered from 1.82±0.1 and 1.78±0.1% to 1.72±0.1 and 1.84±0.1%, respectively when incubated with XIase. When juice is contacted with DPEase >20% of fructose is converted to allulose under given conditions. Addition of both DPEase and XIase simultaneously the formation of allulose is further increased to >21% due increased fructose concentration by inter conversion fructose from glucose by XIase. The amount of allulose reached 6 to 7% of total sugar present in the orange juice, whereas the amount of allulose reached 10 to 11% of total monosaccharides present in the orange juice.

### Example 11

### Alteration of Orange Juice Sugar Composition using Multiple Enzymes

For alteration of sugars present in orange juice the juice was freshly prepared by crushing and subsequent clarification. The freshly prepared fruit juice was having pH 3.25. The freshly prepared juice contains 1.82±0.1% glucose, 1.79±0.1% fructose and 2.2±0.1% of sucrose. Procedure similar to depicted in Example 9 was followed to convert the existing glucose into fructose and/or fructose into allulose and/or sucrose into isomaltulose by XIase and/or DPEase and/or ISase enzymes. After bioconversion, the juice was subjected to HPLC analysis to identify and measure the composition of sugars. The sugar peaks were confirmed with commercially available glucose, fructose, allulose (also known as Psicose), sucrose and isomaltulose (also known as paltinose) standards (Sigma Aldrich). When DPEase, XIase and ISae is added simultaneously, the glucose fructose composition is altered from 1.82±0.1 and 1.79±0.1% to 1.49±0.1 and 1.37±0.1% and >35% of fructose is converted to allulose and >27% sucrose is converted to isomaltulose under given conditions. The amount of allulose reached 20% of total monosaccharides present in the orange juice, whereas the amount of isomaltulose reached 27% of total sucrose present in the orange juice.

1. A process for preparing non-cariogenic, sustained energy release juice comprising:
a) contacting juice with an enzyme immobilized on DUOLITE™ at 30-50° C. for 1-5 h; wherein the enzyme is capable of converting cariogenic sugar to non-cariogenic sugar; and
b) separating juice from the enzyme complex.

2. The process as claimed in claim 1, further comprises optionally,
adjusting pH of the juice before and after contacting with the enzyme immobilized on DUOLITE™.

3. The process as claimed in claim 1, wherein the cariogenic sugar is one or more of a mono-saccharide or di-saccharide.

4. The process as claimed in claim 3, wherein the cariogenic sugar is one or more of sucrose, glucose or fructose.

5. The process as claimed in claim 1, wherein the non-cariogenic sugar is selected from a group comprising isomaltulose, trehalulose and allulose.

6. The process as claimed in claim 1, wherein the enzyme is selected from a group comprising isomaltulose synthase, sucrose isomerase, xylose isomerase, and D-psicose epimerase, and, optionally, along with the enzyme invertase.

7. The process claimed in claim 1, wherein the juice is selected from a group comprising sugar cane juice, sweet sorghum juice, sugar beet juice, orange juice and grape juice.

8. A juice produced by the process as claimed in claim 1.
